(19) United States
(12) Patent Application Publication
(10) Pub. No.: US 2012/0248265 A1
(43) Pub. Date: Oct. 4, 2012

(54) CHAIR BASE AND METHODS FOR THE MANUFACTURE THEREOF

(76) Inventor: Ryan Brill, Allendale, MI (US)

(21) Appl. No.: 13/431,271

(22) Filed: Mar. 27, 2012

Related U.S. Application Data
(60) Provisional application No. 61/468,360, filed on Mar. 28, 2011.

(51) Int. Cl. A47B 91/02; B29C 45/00; A47B 91/00

(52) U.S. Cl. 248/188.2; 248/188.7; 264/328.1

(57) ABSTRACT

A chair base includes a hub having a longitudinally extending interior bore and an exterior surface. The bore includes an upper portion having a first interior wall and a lower portion having a second interior wall. The lower portion is positioned below the upper first portion. A stop feature is positioned between the upper and lower portions. The stop feature extends radially inwardly from at least the first interior wall. In various embodiments, the stop feature is curved. Methods of manufacturing a chair base are also provided.

This application claims the benefit of U.S. Provisional Application No. 61/468,360, filed Mar. 28, 2011, the entire disclosure of which is hereby incorporated by reference.

### TECHNICAL FIELD

The present invention relates generally to a chair base, and in particular, to a molded chair base having a stop feature suitable for engaging a support cylinder and methods for the manufacture thereof.

### BACKGROUND

Often, chair bases are molded from plastic. In many types of conventional office chairs, a support cylinder is engaged with the support base, with the support cylinder providing support to an elevated seating structure. Over time, the support cylinder may experience some creep relative to the base. Various solutions have been developed to address this concern, as shown for example in U.S. Pat. Nos. 5,377,943 to Perl and 5,692,715 to Hertel. Both Perl and Hertel disclose at least one downwardly and inwardly tapered upper wall, and a straight or downwardly and inwardly tapered lower wall, with the lower wall, or a step between the upper and lower walls, engaging the support cylinder to prevent substantial creep. In Hertel, however, some creep may still be experienced, while in Perl, the step may create localized loads. Moreover, slight variations in the taper angles of the interior walls of the base of Hertel may result in variances of the cylinder height, and may be more susceptible to tolerances. Moreover, in either case, the mold is necessarily extracted from the top of the base. Additionally, the molding gate for such constructions typically is not centrally located. Accordingly, the need remains for an improved chair base and method for the manufacture thereof.

### SUMMARY

Briefly stated, in one aspect, one embodiment of a chair base includes a hub having a longitudinally extending interior bore and an exterior surface. The bore includes an upper portion having a first interior wall tapered downwardly and inwardly and a lower portion having a second interior wall tapered downwardly and outwardly. The lower portion is positioned below the upper first portion. A stop feature is positioned between the upper and lower portions. The stop feature extends radially inwardly from the first and second interior walls. At least one support arm extends radially outwardly from the exterior surface.

In another aspect, a method of manufacturing a chair base includes molding a base having a hub with a longitudinally extending interior bore and an exterior surface. The bore includes an upper portion having a first interior wall tapered downwardly and inwardly and a lower portion having a second interior wall tapered downwardly and outwardly. The lower portion is positioned below the upper first portion. A stop feature is positioned between the upper and lower portions. The stop feature extends radially inwardly from the first and second interior walls.

In one embodiment, the method of molding the base includes injecting a plastic into a mold through at least one gate aligned with the stop feature. The method may also include separating first and second mold components along a parting line aligned with the stop feature.

In another aspect, one embodiment of a chair base includes a hub having a longitudinally extending interior bore and an exterior surface. The bore includes an upper portion having a first interior wall tapered downwardly and inwardly and a lower portion having a second interior wall tapered downwardly and inwardly. The lower portion is positioned below the upper first portion. A stop feature is positioned between the upper and lower portions. The stop feature extends radially inwardly from the first interior wall. The stop feature has a longitudinal height and a curved interior surface taken along a vertical cross section thereof.

The various aspects and embodiments provide significant advantages over other chair bases and method for the manufacture thereof. For example and without limitation, the stop feature helps to mitigate creep, and may reduce localized loads. In addition, the stop feature provides consistency in the positioning of the cylinder, while reducing sensitivity to tolerances. At the same time, the molding gate and part line may be provided adjacent the stop feature, so as to provide a more centralized gate, thereby reducing flow lengths during the molding process.

The present invention, together with further objects and advantages, will be best understood by reference to the following detailed description taken in conjunction with the accompanying drawings.

### BRIEF DESCRIPTION OF THE DRAWINGS

FIGS. 1A and B are side and front views of a chair having a chair base.

FIG. 2 is an exploded cross-sectional view of one embodiment of a base and a support cylinder assembly.

FIG. 3 is a cross-sectional view of the base shown in FIG. 2.

FIG. 4 is a cross-sectional view of the base and support cylinder assembly shown in FIG. 2 in an assembled configuration.

FIG. 5 is a cross-sectional view of an alternative embodiment of a base and support assembling in an assembled configuration.

FIG. 6 is a cross-sectional view of the base shown in FIG. 5.

FIG. 7 is a cross-sectional view of an alternative embodiment of a base.

FIG. 8 is a partial schematic cross-sectional illustration of a portion of a mold.

### DETAILED DESCRIPTION OF THE PRESENTLY PREFERRED EMBODIMENTS

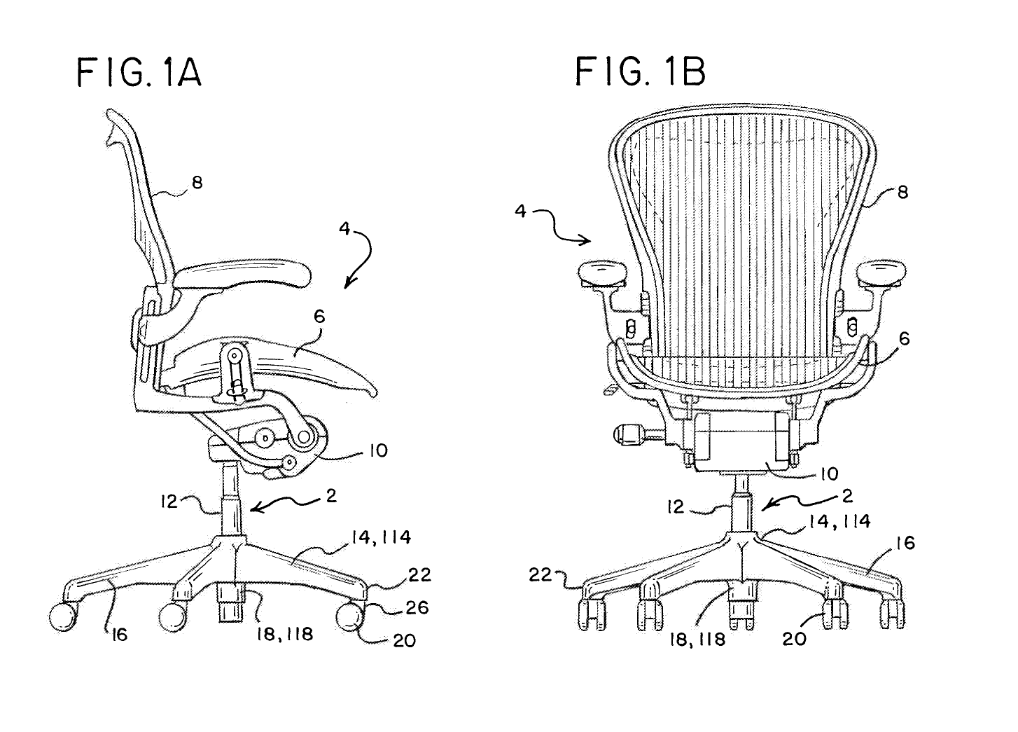

It should be understood that the term “plurality,” as used herein, means two or more. The term “longitudinal,” as used herein means of or relating to length or the lengthwise direction of a support column 2, or assembly thereof. The term “lateral,” as used herein, means directed between or toward (or perpendicular to) the side of the support column. The term “coupled” means connected to or engaged with, whether directly or indirectly, for example with an intervening member, and does not require the engagement to be fixed or permanent, although it may be fixed or permanent. The term “transverse” means extending across an axis, and/or substantially perpendicular to an axis. The terms “upper” and “lower” refer to relative directions of two or more components when the seating structure is in a normal upright position as shown in FIGS. 1A and B. It should be understood that the use of numerical terms “first,” “second,” “third,” etc., as used herein does not refer to any particular sequence or order of components; for example “first” and “second” walls may refer to any sequence or arrangement of such walls, and is not limited to the first and second walls of a particular configuration (e.g., upper and lower) unless otherwise specified.

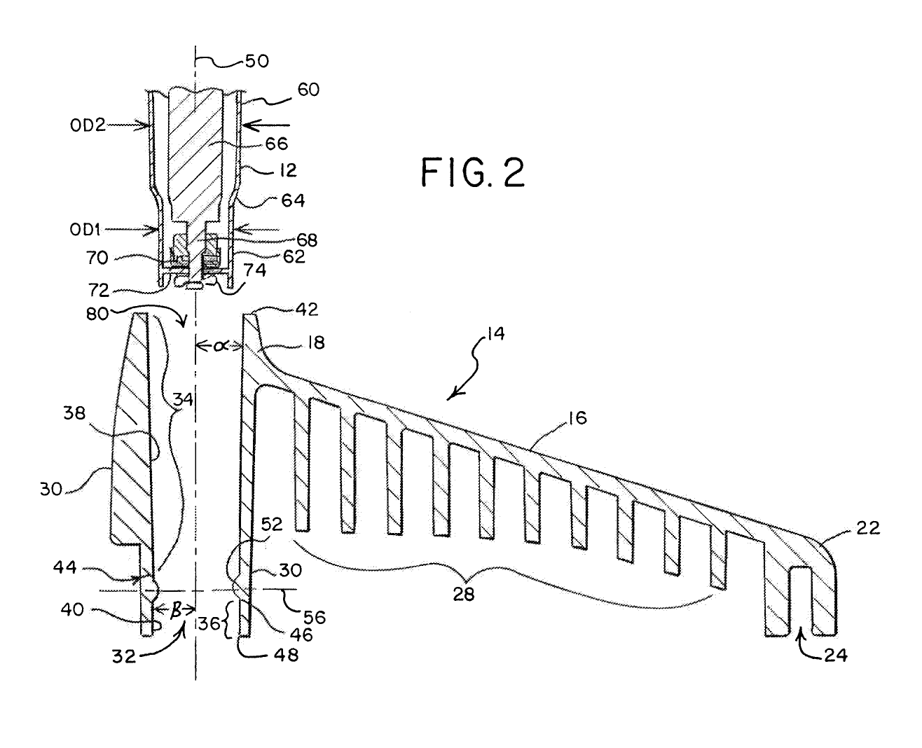

Referring to the drawings, FIGS. 1A and B show a seating structure 4, such as an office chair, having a seat 6 and backrest 8 supported by a tilt control housing 10. The housing 10, in turn, is supported by the support column 2, which is configured with at least one support cylinder 12. The support cylinder is engaged with a base 14, 114. The base 14, 114 has a plurality of support arms 16 extending radially from a central hub 18, 118. At least one floor interface component 20 is coupled to a free end 22 of each support arm. The floor interface component 20 may be configured as a glide, caster (shown in FIGS. 1A and B), pad, or other known and suitable devices, or combinations thereof. As shown in FIGS. 2-4, the free end 22 may include an opening 24 shaped to receive the interface component 20. For example, the opening 24 may have a suitable diameter and depth sized to receive and engage a shaft 26 extending upwardly from a caster 20 or glide. It should be understood that the seating structure may include a plurality of support columns, with a single base supporting the support columns, or a plurality of bases being provided. Referring to FIGS. 2-4 and 6, the support arms 16 are each configured with a plurality of support ribs 28.

The hub 18, 118 includes an exterior surface 30 from which the support arms extend. The hub 18, 118 also is configured with an interior bore 32, 132. In one embodiment, the bore 32, 132 has an upper portion 34 having an interior wall 38. The interior wall 38 is tapered downwardly and inwardly from a top 42 of the upper portion to a bottom 44 thereof. The taper of the walls corresponds to the draft 112 of the upper mold 102 shown in FIG. 8. In various embodiments, the interior wall 38 and draft 112 forms an angle α of greater than or equal to 0 degrees, and in various embodiments between about 1 and 5 degrees relative to the longitudinal axis 50. In one embodiment, the wall is configured with a Morse #3 Taper, wherein α=1 deg, 26 min 16 sec.

Referring to FIGS. 2-4, the bore 32 also includes a lower portion 36 having an interior wall 40. The interior wall 40 is tapered downwardly and outwardly from a top 46 of the lower portion to a bottom 48 thereof. The taper of the walls corresponds to the draft 113 of the lower mold 104 shown in FIG. 8, with the taper and drafts 112, 113 being angled in opposition to each other such that the upper and lower molds 102, 104 may be separated and removed from the base. In various embodiments, the interior wall 40 and draft 113 forms an angle β of greater than or equal to 0 degrees, and in various embodiments between about 1 and 5 degrees relative to the longitudinal axis 50. In one embodiment, the interior wall is has an angle of about 2 degrees.

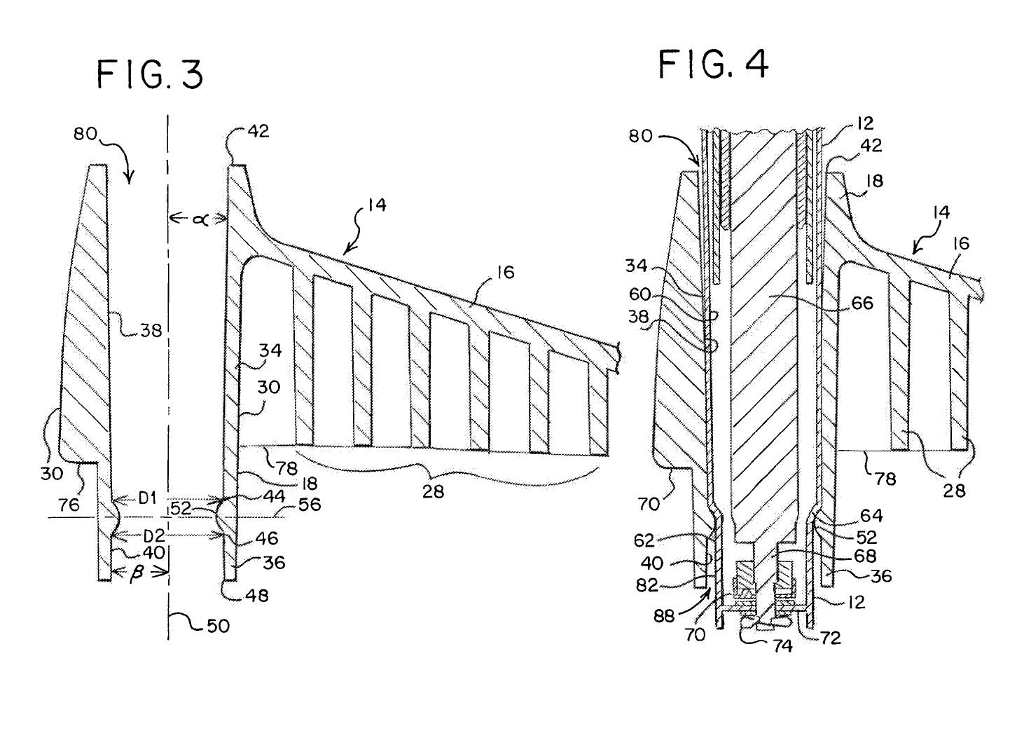

A stop feature 52 is positioned between the upper and lower portions 34, 36 of the bore 32. It should be understood that in one embodiment, the lower portion may be omitted, with the stop feature 52 positioned at the bottom of the hub. The stop feature 52 extends radially inwardly from the interior walls 38, 40. In one embodiment, the stop feature 52 is formed as an annular ring extending around a periphery of the interior bore within a plane 56 substantially perpendicular to the longitudinal axis 50. The stop feature 52 may assume various shapes, including a convex shape, formed for example as a semi-spherical protuberance. In other embodiments, the stop feature 52 may have a concave shape, whether on one or both of an upper and lower surface of the stop feature, or be tapered, again on one or both of the upper and lower surfaces. In this way, the stop feature 52 may be symmetrical about the horizontal plane 56. Due to the protuberance of the stop feature from the interior walls 38, 40, the stop feature is located along the parting lines 106 of the mold 100 such that the mold halves 102, 104 may be separated. Of course, it should be understood that the stop feature may be unsymmetrical about a horizontal plane. Moreover, the stop feature may be configured as a plurality of radially extending protuberances angularly spaced around the periphery of the interior bore. In one embodiment, the diameter D2 of the lower 36 portion adjacent the stop feature 52 is substantially the same, or greater than, the diameter D1 of the upper portion 34 adjacent the stop feature 52 as shown in FIG. 3.

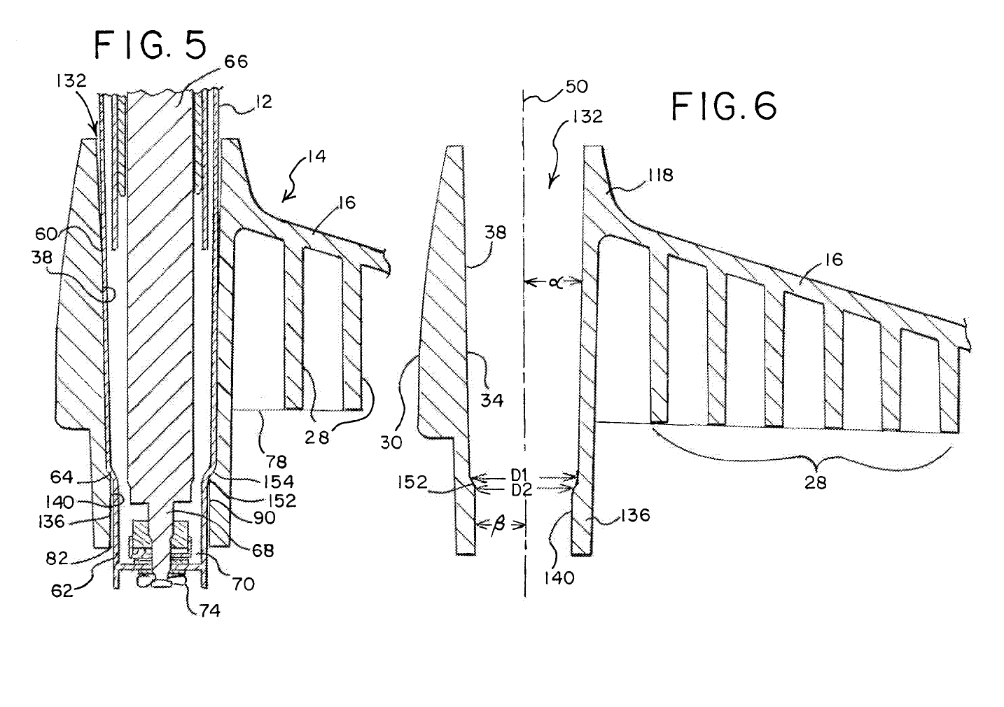

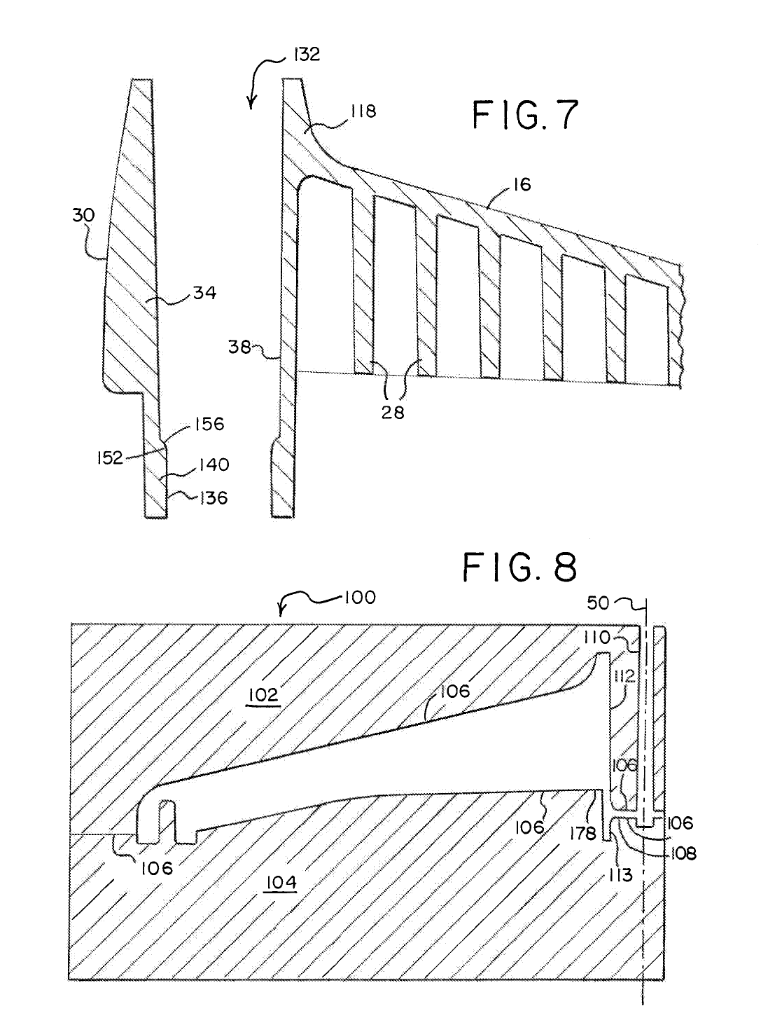

Referring to FIGS. 5-7, another embodiment of a base 114 includes a hub 118 with a lower portion 136 having an interior wall 140 tapered downwardly and inwardly, for example at the same angle α and draft as the interior wall 38 of the upper portion 34, with a parting line defined along the bottom of the hub. In this embodiment, the diameter D2 of the lower portion adjacent the stop feature is less than the diameter D1 of the upper portion. In this embodiment, the transition between the upper and lower portions forms a stop feature 152. The stop feature 152 may have a concave outer surface 154 as shown in FIGS. 5 and 6, or a convex outer surface 156 as shown in FIG. 7. In this embodiment, the diameter D2 of the lower portion 136 adjacent the stop feature 152 is less than the diameter D1 of the upper portion 134.

Referring to FIGS. 2, 4 and 5, the support cylinder 12 is configured with an upper tubular portion 60 and a lower tubular portion 62, with a shoulder 64 transitioning between the upper and lower tubular portions. The shoulder may be formed by a rolled edge. In one embodiment, where the tubular portions have a circular cross-section, the lower tubular portion 62 has a smaller outer diameter OD1 than the outer diameter OD2 of the upper tubular portion 60. In other embodiments, the support column may have non-cylindrical cross-sections. A biasing device 66, such as a pneumatic/gas spring, hydraulic cylinder, screw system (manual or driven by a servo motor), or other mechanical devices, is disposed in the support cylinder, and may be extensible to allow for the height of the seating structure to be adjusted. In some embodiments, the upper and lower portions 60, 62 of the support cylinder 12 form a first stage of the support column, which may include other stages interfacing therewith. In other embodiments, the support column is configured with only a single stage, and/or may be fixed in height. It should be understood that the housing of the gas spring itself may define the support cylinder.

The gas spring 66 may include a piston rod 68 secured to a bottom wall 72 of the support cylinder with a fastener 74, such as a clip. The piston rod 68, and gas spring 66, are supported by an axial bearing 70, such that the gas spring may rotate about the longitudinal axis 50. In one embodiment, the support cylinder is made of metal such as steel or aluminum, or alternatively of composite materials, plastic, etc., or combinations thereof. In one embodiment, the upper tubular portion has an outer diameter OD2 of 50 mm, while the lower tubular portion has an outer diameter OD1 of 40 mm.

Referring to FIG. 8, the base 12, including the hub 12 and one or more support arms 16, is integrally formed by injection molding using the mold 100. The base may be made from glass filled thermoplastic elastomers. One suitable material may be 30% GF PA6. The mold has at last one gate 108 positioned such that it is aligned with the stop feature 52. In addition, the mold has first and second mold components 102, 104 that part adjacent the stop feature 52 along parting line 106. In this way, the first and second molds 102, 104 may be separated and removed from the base in opposite directions due to the opposed drafts 112, 113 defining the interior walls 38, 40 of the upper and lower portions, and corresponding mold components 102, 104. Due to the location of the mold gate 108 at a more central location to the base (measured along the longitudinal axis 50), the flow of material to various portions of the mold is more uniform and efficient due to a reduced flow length. In one embodiment, the stop feature, and hence the gate 108, are located below a portion 76 of the hub and below a portion 78 of the support arm (and portion 178 of the mold) located adjacent the juncture of the support arm with the hub, as shown in FIGS. 3 and 8. It should be understood that the stop feature may be located at other locations relative to the support arm, including in alignment with or above the support arm. As shown in FIG. 8, a sprue 110 extends downwardly through the mold and communicates with the gate 108. In other embodiments, the mold and molding process may include a collapsible core or involve reverse ejection, with the parting line being located elsewhere.

During the assembly of the base, shown in FIGS. 2 and 4, the support cylinder 12 is introduced to the bore through a top opening 80, with the lower portion 62 of the support cylinder passing the stop feature 52 and being located at least partially in the lower portion 36 of the bore. As shown in FIG. 4, a clearance or gap 88 is provided between an outer surface 82 of the lower portion 62 of the support cylinder and the interior surface 40 of the lower portion 36 of the bore. The upper portion 60 of the support cylinder is engaged with the interior surface 38 of the upper portion of the bore, while the transition or shoulder 64 of the support cylinder is engaged with the stop feature 52 to prevent creep of the support cylinder through the bore, and provide a more precise positioning of the cylinder relative to the base. In one embodiment, the support cylinder 12 is pressed into the bore 32 with a 1000 lb pressing operation.

The assembly of the base shown in FIG. 5 is similar, with the support cylinder 12 being inserted into the bore 132 with the upper portion 60 engaging the interior wall 38 the upper portion 34 and with the lower portion 136 having a clearance or gap 90 between the inner surface 140 and the outer surface 82 of the lower portion 62 of the support cylinder. The transition or shoulder 64 of the support cylinder engages the stop feature 152 formed in the bore.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A chair base comprising:
a hub comprising a longitudinally extending interior bore and an exterior surface, said bore comprising:
an upper portion having a first interior wall tapered downwardly and inwardly;
a lower portion having a second interior wall tapered downwardly and outwardly, wherein said lower portion is positioned below said upper portion; and
a stop feature positioned between said upper and lower portions, said stop feature extending radially inwardly from said first and second interior walls; and
at least one support arm extending radially outwardly from said exterior surface.

2. The chair base of claim 1 wherein said stop feature is annular and extends around a periphery of the interior bore within a plane substantially perpendicular to a longitudinal axis of said interior bore.

3. The chair base of claim 2 wherein said stop feature has a convex shape.

4. The chair base of claim 1 further comprising at least one floor interface member coupled to an end of said at least one support arm.

5. The chair base of claim 1 wherein said second interior wall forms an angle of between about 1 and 5 degrees relative to a longitudinal axis of said interior bore.

6. The chair base of claim 1 wherein said first interior wall forms an angle of between about 1 and 5 degrees relative to a longitudinal axis of said interior bore.

7. The chair base of claim 1 further comprising a support cylinder having an upper tubular portion, a lower tubular portion and a shoulder transitioning between said upper and lower tubular portions, wherein said lower tubular portion has a smaller diameter than said upper tubular portion, wherein said upper tubular portion is disposed in said upper portion of said bore, at least a portion of said lower tubular portion is disposed in said lower portion of said bore, and said shoulder is engaged with said stop feature.

8. The chair base of claim 7 further comprising a gas spring disposed in said support cylinder.

9. The chair base of claim 1 wherein said stop feature is spaced below a bottom surface of a portion of said at least one support arm located adjacent the juncture of said exterior surface and said at least one support arm.

10. A method of manufacturing a chair base comprising:
molding a base including a hub comprising a longitudinally extending interior bore and an exterior surface, wherein said bore comprises an upper portion having a first interior wall tapered downwardly and inwardly, a lower portion having a second interior wall tapered downwardly and outwardly, wherein said lower portion is positioned below said first portion, and a stop feature positioned between said upper and lower portions, said stop feature extending radially inwardly from said first and second interior walls.

11. The method of claim 10 wherein said molding said base comprises injecting a plastic into a mold through at least one gate aligned with said stop feature.

12. The method of claim 10 wherein said molding said base comprises separating first and second mold components along a parting line aligned with said stop feature.

13. The method of claim 10 wherein said molding said base further comprises integrally molding at least one support arm with said hub, wherein said at least one support arm extends radially outwardly from said hub.

14. The method of claim 13 further comprising removing said molded base from a mold after said molding and coupling at least one floor interface member to an end of said at least one support arm.

15. The method of claim 13 wherein said stop feature is disposed below a portion of said at least one support arm located adjacent the juncture of said exterior surface and said at least one support arm.

16. The method of claim 10 wherein said stop feature is annular and extends around a periphery of the interior bore within a plane substantially perpendicular to a longitudinal axis of said interior bore.

17. The method of claim 16 wherein said stop feature has a convex shape.

18. A chair base comprising:
a hub comprising a longitudinally extending interior bore and an exterior surface, said bore comprising:
an upper portion having a first interior wall tapered downwardly and inwardly;
a lower portion having a second interior wall tapered downwardly and inwardly, wherein said lower portion is positioned below said upper portion; and
a stop feature positioned between said upper and lower portions, said stop feature extending radially inwardly from said first interior wall, wherein said stop feature has a longitudinal height and a curved interior surface taken along a vertical cross section thereof; and
at least one support arm extending radially outwardly from said exterior surface.

19. The chair base of claim 18 wherein said curved interior surface is concave.

20. The chair base of claim 18 wherein said curved interior surface is convex.
